(19) United States
(12) Patent Application Publication
(10) Pub. No.: US 2009/0309796 A1
(43) Pub. Date: Dec. 17, 2009

(54) ANTENNA ARRANGEMENT FOR A PORTABLE RADIO COUMMUNICATION DEVICE, AND A PORTABLE RADIO COMMUNICATION DEVICE COMPRISING SUCH AN ANTENNA ARRANGEMENT

(76) Inventors: Greger Byström, Akersberga (SE); Östervall Torsten, Stockholm (SE)

Correspondence Address: HARNESS, DICKEY, & PIERCE, P.L.C, 7700 Bonhomme, Suite 400, ST. LOUIS, MO, 63105, US

(21) Appl. No.: 12/278,615

(22) PCT Filed: Feb. 7, 2007
(86) PCT No.: PCT/SE07/00114

§ 371 Date: Nov. 19, 2008

(51) Int. Cl. H01Q 1/38; H01Q 1/24

(52) U.S. Cl. 343/702; 343/700 MS

(57) ABSTRACT

The present invention relates to an antenna arrangement for a portable radio communication device, such as a mobile phone, and a portable radio communication device comprising such an antenna arrangement. The antenna arrangement is characterized in that a first connection portion (14, 15; 19, 20; 22, 23, 24, 25) has a first segment extending between a flexible antenna element (10) and a connection device (11) and a second connection portion (14, 15; 19, 20; 22, 23, 24, 25) has a second segment extending between the flexible antenna element (10) and the connection device (11), such that the sum of the extensions is constant irrespectively of mounting displacement of the flexible antenna element (10) on a support structure (9).

### FIELD OF THE INVENTION

The present invention generally relates to antenna arrangements. Particularly, the present invention relates to an antenna arrangement for a portable radio communication device.

### BACKGROUND OF THE INVENTION

As portable radio communication devices, such as mobile phones, become smaller the electronic components contained within the devices, e.g. the antennas, will also need to be smaller. The electrical connections between these components are realized by means of connectors, which should provide good and well-defined electrical contact between the components and which should be insensitive to small variations, which always occurs, in manufacturing and mounting processes.

Therefore, an elastic type or a spring type of connector is becoming increasingly attractive for small components. Such connectors are known to provide reliable electrical connection between components. Spring features of a connector provide a well-defined contact and the flexibility to avoid tolerances build up when manufacturing dimensions are not all perfectly exact. The compliance is also needed to accommodate departures from planarity as is common in high volume manufacturing processes where contact pads may not be exactly planar.

The conventional method of electrically connecting an electronic component, being of a miniature size, is to interpose, between the electronic component and a printed circuit board, an electrical connector such as a spring-loaded contact (SLC), e.g. called a Pogo Pin™.

In U.S. Pat. No. 6,812,899 an antenna arrangement is disclosed utilizing SLCs to connect an antenna element to a PCB. Such an antenna arrangement of the above-mentioned US patent is illustrated in FIGS. 1 and 2. The antenna arrangement comprises an antenna element 1 supported by a support structure 2. The support structure 2 comprises a first and a second aperture 5 and 6, into which a first and a second connection portion 7 and 8 are positioned. A first and a second connection device 3 and 4, such as SLCs, are arranged in the apertures 5 and 6 to fixate the connection portions 7 and 8 to the support structure 2 and to ensure electrical contact between the antenna element 1 and the first and second connection devices 3 and 4.

A problem with the antenna arrangement disclosed in the above-mentioned US patent is illustrated in FIGS. 3-5. FIG. 3 illustrate the two apertures 5 and 6, for simplicity positioned adjacent each other. When the antenna element 1 is mounted in a correct position on the support structure 2 the connection portions 7 and 8 have a desired length extending in the plane of the antenna element 1, as illustrated in FIG. 3. When the antenna element 1 is mounted in a position displaced from the correct position the length of the connection portions 7 and 8 extending in the plane of the antenna element 1 either is increased or decreased as illustrated in FIGS. 4 and 5 respectively. Such mounting deviations result in that the resonance frequency/frequencies for the antenna arrangement deviates from the desired resonance frequency/frequencies, which is not desirable.

### SUMMARY OF THE INVENTION

An object of the present invention is to provide an antenna arrangement that minimize the above-mentioned problem.

This object, among others, is according to the present invention attained by an antenna arrangement and a portable radio communication device, respectively, as defined in the appended claims.

By a first connection portion of a flexible antenna element having a first segment extending between a flexible antenna element and a connection device and a second connection portion of the antenna element having a second segment extending between the flexible antenna element and the connection device, the sum of the extensions is constant irrespectively of mounting displacement of the flexible antenna element on a support structure. Thus, the effect on the resonance frequency of the antenna arrangement caused by mounting displacement of the flexible antenna element on a support structure is minimized.

Further features and advantages of the present invention will be evident from the following description.

### BRIEF DESCRIPTION OF THE DRAWINGS

The present invention will become more fully understood from the detailed description of embodiments given below and the accompanying drawings, which are given by way of illustration only, and thus, are not limitative to the present invention, wherein:

FIG. 1 illustrates an antenna arrangement according to prior art;

FIG. 2 shows contact devices in a mounted position of the antenna arrangement illustrated in FIG. 1;

FIG. 3 illustrates a correctly mounted antenna element according to prior art;

FIG. 4 illustrates an incorrectly mounted antenna element according to prior art;

FIG. 5 illustrates an incorrectly mounted antenna element according to prior art;

FIG. 6 illustrates an antenna arrangement according to a first embodiment of the present invention;

FIGS. 7a-b illustrate an antenna element mounted in a desired position in according with a first embodiment of the present invention;

FIGS. 8a-b illustrate an antenna element mounted displaced from a desired position in according with the first embodiment of the present invention;

FIGS. 9a-d illustrate different shapes of a connection portion of an antenna element according to the present invention;

FIG. 10 illustrates a comparison of the normal distribution for an antenna element having two connection portions and the normal distribution for an antenna element having a single connection portion;

FIG. 11 illustrates a cross-section of an aperture according to a second embodiment of the present invention;

FIG. 12 illustrates an antenna element mounted in a desired position in according with a second embodiment of the present invention, without a connection device;

FIG. 13 illustrates an antenna element mounted displaced from a desired position in according with the second embodiment of the present invention, without a connection device; and

FIG. 14 illustrates an antenna element according to a third embodiment of the present invention.

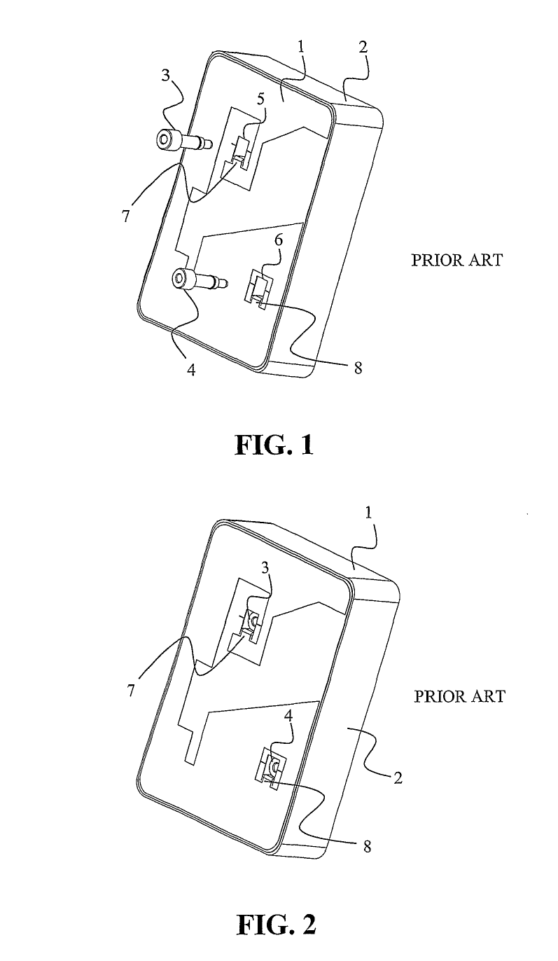

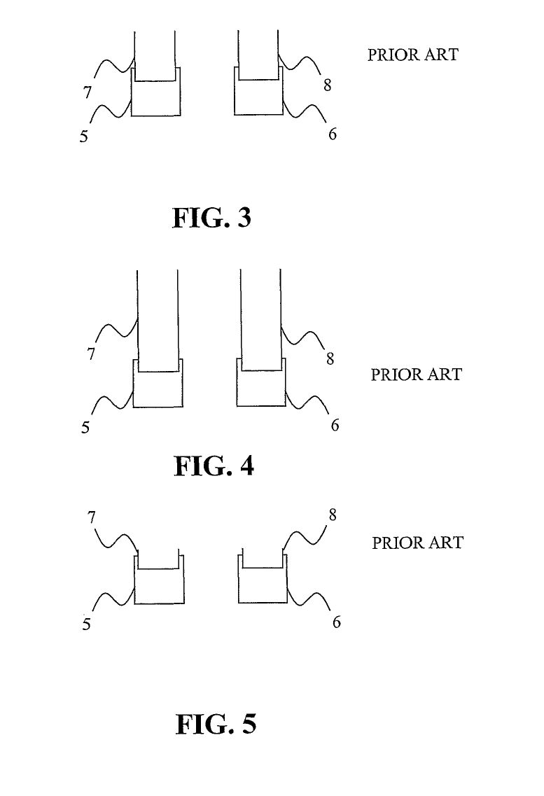

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

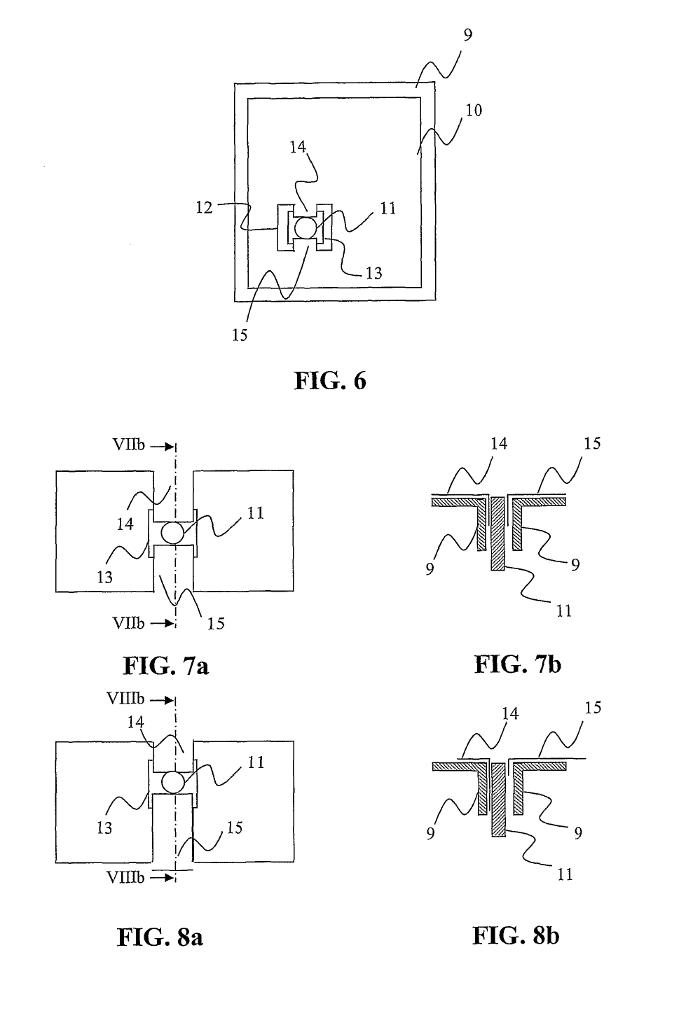

A first embodiment of the present invention will now be described with reference to FIGS. 6-9.

An antenna arrangement for a portable radio communication device, such as e.g. a mobile phone, a PDA or a portable computer, comprises a substantially planar flexible antenna element 10, such as a flex film antenna element, and a support structure 9 for support of the antenna element 10. The flexible antenna element 10 includes two connection portions 14 and 15, e.g. for feeding the antenna or for grounding the antenna. The connection portions 14, 15 are preferably provided by punching out part 12 of the flexible antenna element 10, resulting in two connection portions 14, distanced from the rest of the antenna element 10. Alternatively the connection portions 14, 15 can be provided by cutting a pattern in the flexible antenna element 10.

The support structure 9 includes an aperture 13 for receiving an outer end of the connection portions 14 and 15. The antenna arrangement further comprises a connection device 11, which preferably has a longitudinal axis, such as SLCs or contact sheets, for connecting the antenna element 10 to RF circuitry (i.e. feeding or grounding) of the portable radio communication device. The expression longitudinal axis is used to define the direction through the aperture. The aperture 13 is further for receiving the connection device 11.

The connection device 11 is arranged to fixate the outer ends of the two connection portions 14 and 15 in the aperture 13 by means of radial forces. An upper end of the connection device 11 fixates the outer end of each connection portion 14 and 15 in the aperture 13 and thereby electrically connects to the antenna element 10. This upper end of the connection device 11 is of uniform thickness along a length that preferably correspond to the length of each connection portion 14 and 15 that extend down into the aperture 13. The other end of the connection device 11 is preferably axially resilient, for connection to a printed wiring board of the portable radio communication device, for connection to the RF circuitry of the portable radio communication device. Due to the axial resilience of the connection device 11 the radial forces necessary to prevent axial displacement of the connection device is greatly reduced, when the antenna arrangement is mounted to a printed wiring board of the portable radio communication device.

The aperture 13 has a square shaped cross-section, such that at least the sides receiving the connection portions 14 and 15 are planar. Further, the connection device 11 preferably has a circularly shaped cross-section, such that at least the parts contacting the connection portions 14 and 15 have a rounded surface. In this way a well-defined contact is achieved between the connection portions 14 and 15 and the connection device 11.

The antenna arrangement is by the above-described configuration easily adapted to requirements on the space an antenna arrangement may occupy in a housing of e.g. a mobile telephone and contact positions on a printed wiring board for connection to RF circuitry in the mobile telephone. The support structure 9 is easily adapted to fit a specific volume. The aperture 13 is easily provided in different positions in the support structure 9 in connection with a desired contact position on the printed wiring board. The flexible antenna element 10 is mounted to the support structure 9. The outer ends of the connection portions 14, 15 are positioned in the aperture 13. The connection device 11 is positioned in the aperture 13, fixating the outer ends of the connection portions 14, 15 in the aperture 13 and electrically connects them thereto. A stopper may also be provided in the aperture 13 to prevent the connection device 11 from being pushed to deep into the aperture 13, which facilitates mounting of the connection device 11.

In an alternative mounting process, the outer ends of the connection portions 14, 15 may initially be positioned above the aperture 13, instead of in the aperture 13, to subsequently be positioned into the aperture 13 by means of the positioning of the connection device 11 into the aperture 13.

The antenna arrangement is then ready to be positioned in the housing of e.g. a mobile telephone. It is not necessary to know the exact distance between the support structure 9 and the contact positions on the printed wiring board of the portable radio communication device when the connection device 11 is axially resilient. The axial resilience further lowers the radial forces needed to maintain the connection device 11 in the aperture 13.

The connection portions 14 and 15 each have a segment extending from the substantially planar flexible antenna element 10 to the connection device 11, which is substantially in a plane defined by the substantially planar flexible antenna element 10. When the substantially planar flexible antenna element 10 is mounted to the support structure 9 to a desired position the extensions of the segments of the connection portions 14, 15 extend an equal amount from the aperture 13, which is illustrated in FIG. 7. FIG. 7 is schematic and distances between different parts are highly exaggerated to illustrate their relative positions. However, if the mounting of the substantially planar flexible antenna element 10 onto the support structure 9 is displaced from the desired position the connection portions 14, 15 will extend to a different degree from the aperture 13, which is illustrated in FIG. 8. Also FIG. 8 is schematic and distances between different parts are highly exaggerated to illustrate their relative positions. The electrical length of the sum of the extensions of the connection portions 14, 15 in the plane defined by the substantially planar flexible antenna element 10 will still be the same as when the substantially planar flexible antenna element 10 is mounted in the desired position. This will thus result in reduced frequency spreading for the antenna arrangement due to mounting displacement of the substantially planar flexible antenna element 10 to the support structure 9. The amount of the connection portions extending down into the aperture along the connection device 11, i.e. the outer parts of the connection portions, is not relevant for frequency as the connection device 11 is the main conductive element in the aperture.

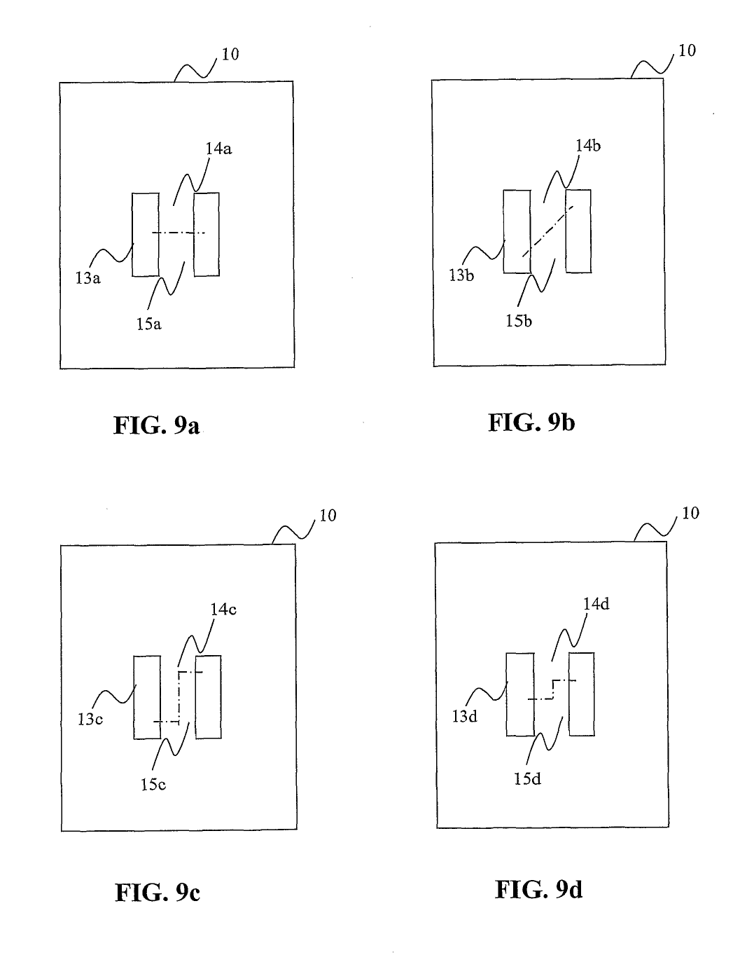

The shape of the connection portions is preferably cut by the above-described punch-outs, which removes some parts of the antenna element, to form the connection portions within the antenna element. In FIGS. 9a-d are four different shapes of the connection portions illustrated: rectangular, triangular and long and short semi cuts. An advantage with the rectangular-shaped connection portion in FIG. 9a is that it is easy to mount due to it symmetry, but at the same time is the length of the connection portion limited to the size of the aperture.

Apart from being an improvement compared to the prior art as mentioned above, the present invention has it greatest advantage for antenna elements utilizing only one connection device, as each connection device minimizes frequency deviations due to displaced mounting position.

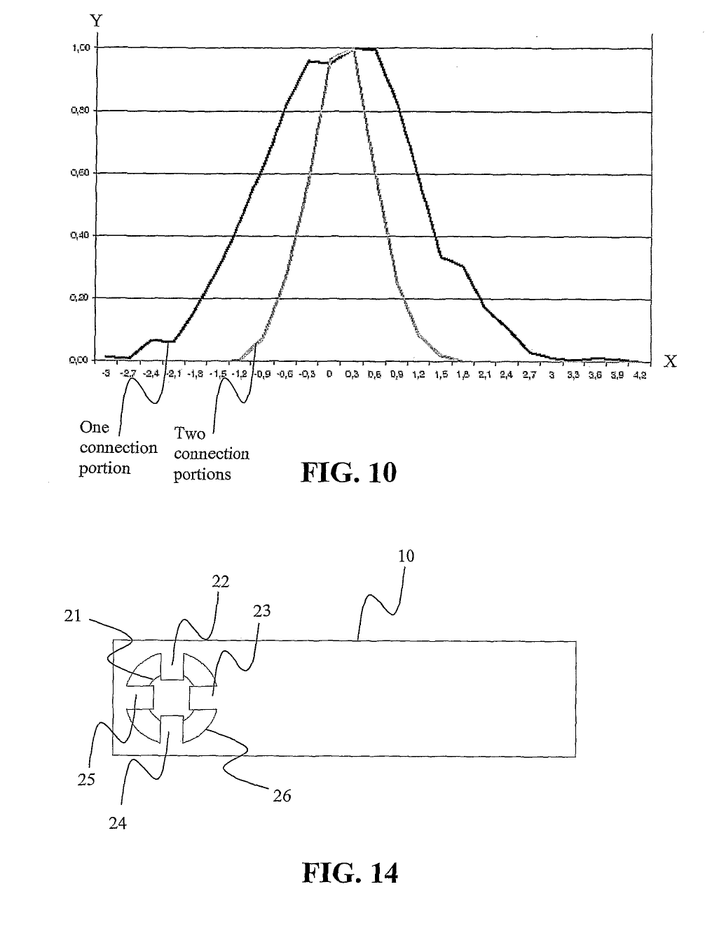

FIG. 10 shows a histogram comparison of frequency deviation for a connection device connected to an antenna element having a single connection portion as in prior art to a connection device connected to an antenna element having two connection portions as described above. The X-axis shows frequency deviation. The Y-axis shows normalized occurrence of a specific frequency deviation. Having two or more connection portions according to the present invention is thus very advantageous compared to a single connection portion as in prior art due to reduced scrap level in production. The design of the present invention is moreover significantly more robust compared to prior art.

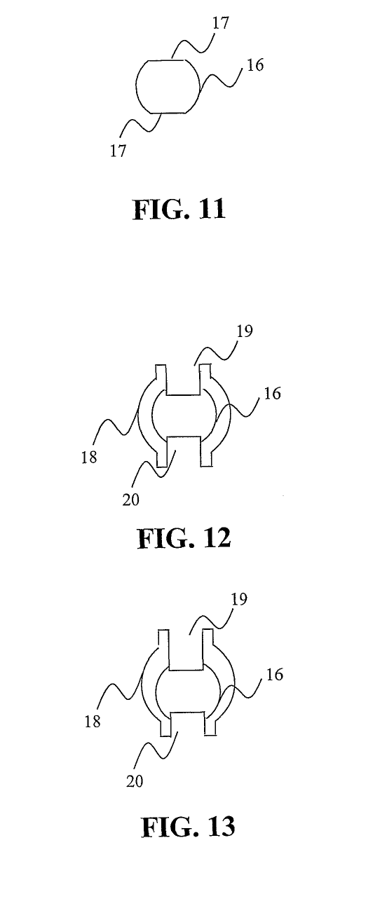

A second embodiment of the present invention will now be described with reference to FIGS. 11-13. This second embodiment of the present invention is identical to the first embodiment described above, apart from the following.

The aperture 16 has a cross-section of two arc-shaped portions with two planar portions 17 there between. The planar portions 17 are for receiving parts of the connection portions 19 and 20. Thus, a rounded surface of the connection device (not shown to not clutter the figure) presses against the connection portions 19 and 20, which are supported by a planar surface. Also, a rounded surface of the connection device (not shown) presses against a correspondingly rounded surface of the circular part of the aperture 16. Preferably, the punch-out 18 of the substantially planar flexible antenna element antenna element is also substantially circular, which provides for further reduction in frequency deviations.

A third embodiment of the present invention will now be described with reference to FIG. 14. This third embodiment of the present invention is identical to the second embodiment described above, apart from the following.

The antenna element 10 is shaped with four connection portions 22, 23, 24 and 25, for mounting in the aperture 21 having four planar portions between arc-shaped portions. The punch-out 26 of the antenna element 10 is further essentially circular.

Alternatively the antenna element can be shaped with three or five or more connection portions. Further, the connection portions of the above embodiments have been illustrated as symmetrically distributed around the connection device, which they preferably also are.

A connection device described in the embodiments above may e.g. be used for grounding when the antenna element is a parasitic element, or for feeding when no grounding point is necessary, such as for a folded monopole. Further, two or more connection devices may used for an antenna arrangement, e.g. for feeding and grounding, respectively, an antenna element, or for several feeding and/or grounding points, wherein each connection point may be formed according to the present invention as described above.

The above used term flex film, should be interpreted as a flexible and thin material comprising conductive portions such as wires or bands.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

The antenna element 10 has been described as being substantially planar. It will be appreciated that the antenna element can take other shapes, such as a convex shape, without departing from the inventive idea.

1. An antenna arrangement for a portable radio/communication device, said antenna arrangement comprising:
a flexible antenna element (10) comprising a first and a second connection portion (14, 15; 19, 20; 22, 23, 24, 25);
a support, structure (9) supporting said flexible antenna element (10) and comprising an aperture (13; 16; 21); and
a connection device (11) for connecting said flexible antenna element (10) to the portable radio communication device, wherein said connection device (11) is positioned in said aperture (13; 16; 21), characterized in that
said connection device (11) fixates said first and second connection portions (14, 15; 19, 20; 22, 23, 24, 25) to said support structure (9) and electrically connects said first and second connection portions (14, 15; 19; 20; 22, 23; 24, 25) to said connection device (11) by means of radial forces;
said first connection portion (14, 15; 19, 20; 22, 23, 24, 25) has a first segment extending between said flexible antenna element (10) and said connection device (11);
said second connection portion (14, 15; 19, 20; 22, 23, 24, 25) has a second segment extending between, said flexible antenna element (10) and said connection device (11), such that the sum of said extensions is constant irrespectively of mounting displacement of said flexible antenna element (10) on said support structure (9).

2. The antenna arrangement as, claimed in claim 1, wherein said connection device (11) has a longitudinal axis and is axially resilient for connection to said portable radio communication device.

3. The antenna arrangement as claimed in claim 1, wherein said connection portions (14, 15; 19, 20; 22, 23, 24, 25) are elongated.

4. The antenna arrangement as claimed in claim 3, wherein said connection portions (14, 15; 19, 20; 22, 23, 24, 25) are rectangular-shaped.

5. The antenna arrangement as claimed in claim 1, wherein said antenna element (10) comprises a punch out (13; 18; 26) forming said connection portions (14, 15; 19, 20; 22, 23, 24, 25).

6. The antenna arrangement as claimed in claim 1, wherein said aperture (16; 21) has a partly arc-shaped and partly planar-shaped cross-section for supporting said connection device (11).

7. The antenna arrangement as claimed in claim 6, wherein said aperture (16; 21) comprises two planar surfaces (17) for supporting said connection portions (19, 20; 22, 23, 24, 25).

8. The antenna arrangement as claimed in claim 1, wherein said antenna element (10) is substantially/planar.

9. The antenna arrangement as claimed in claim 1, comprising a third connection portion, which is fixated by said connection portion (11) to said support structure (9) and has a third segment extending between said flexible antenna element (10) and said connection device (11).

10. The antenna arrangement as claimed in claim 9, comprising a fourth connection portion, which is fixated by said connection portion (11) to said support structure (9) and has a fourth segment extending between said flexible antenna element (10) and said connection device (11).

11. A portable radio communication device, characterized in that it comprises an antenna arrangement according to claim 1.
